(19) United States
(12) Patent Application Publication
(10) Pub. No.: US 2026/0161248 A1
(43) Pub. Date: Jun. 11, 2026

(54) Touch Display Device

(71) Applicant: LG Display Co., Ltd., Seoul (KR)

(72) Inventor: KwanWoong Park, Paju-si (KR)

(21) Appl. No.: 19/371,846

(22) Filed: Oct. 28, 2025

(30) Foreign Application Priority Data
Dec. 6, 2024 (KR) 10-2024-0180441

(51) Int. Cl. G06F 3/041; G06F 3/044

(52) U.S. Cl. CPC G06F 3/04164; G06F 3/0412; G06F 3/04182; G06F 3/0446; G06F 2203/04111

(57) ABSTRACT

The present disclosure provides to a touch display device including a touch driving circuit connected a dummy touch line overlapping with a plurality of touch lines through at least one dummy touch terminal.

### CROSS REFERENCE TO RELATED APPLICATION

This application claims priority from Republic of Korea Patent Application No. 10-2024-0180441 filed on December 6, 2024, which is hereby incorporated by reference in its entirety.

### TECHNICAL FIELD

The present disclosure relates to electronic devices, and more specifically, to touch display devices.

### BACKGROUND

In today's information society, display devices for presenting images or visual information to users are increasingly important. The need for such display devices has caused display technology to be rapidly developed, and various types of display devices, such as a liquid crystal display (LCD) device, an organic light emitting diode (OLED) display device, and the like, have been developed and used.

Among such display devices, touch display devices employing a touch-based input interface developed from typical input devices, such as buttons, keyboards, mice, and the like, are becoming increasingly popular because they enable users to input information or commands intuitively and conveniently.

However, in the case of touch display devices, when a defect occurs in a related touch module during the manufacturing process, there may be no repair method to cure the defect, and therefore, the defective touch module is discarded. Accordingly, there is an increasing need for technology to repair touch defects to improve yield.

### SUMMARY

To address this issue, one or more embodiments of the present disclosure may provide a touch display device capable of repairing a defect in a touch line by using a dummy touch line.

One or more embodiments of the present disclosure may provide a touch display device capable of effectively repairing a defect in a touch line by using a dummy touch line with a loop shape.

One or more embodiments of the present disclosure may provide a touch display device capable of minimizing or at least reducing yield loss due to discarding of defective touch modules, optimizing the manufacturing process, and reducing manufacturing costs by effectively repairing a defect in a touch line.

Aspects, examples, and embodiments provided in the present disclosure are not limited to the foregoing description, and additional aspects, examples, and embodiments provided in the present disclosure will become apparent to those skilled in the art from the following description.

In one embodiment, a touch display device comprises: a display panel comprising a plurality of subpixels that display an image, a plurality of touch electrodes that perform touch sensing, a plurality of touch lines that are connected to the plurality of touch electrodes, and a dummy touch line; and a touch driving circuit electrically connected to the plurality of touch electrodes through the plurality of touch lines, the touch driving circuit including at least one dummy touch terminal connected to the dummy touch line, wherein the dummy touch line overlaps the plurality of touch lines.

In one embodiment, a touch display device comprises: a substrate; a plurality of insulating layers on the substrate; a light emitting element layer on the plurality of insulating layers, the light emitting element layer emitting light; a first touch insulating layer on the light emitting element layer; a plurality of touch lines on the first touch insulating layer; a second touch insulating layer on the first touch insulating layer, the second touch insulating layer covering the plurality of touch lines, and a dummy touch line at least partially overlapping with at least one of the plurality of touch lines, the dummy touch line connected to at least one dummy touch terminal in a touch driving circuit.

A touch display device comprising: a display panel comprising a plurality of subpixels that display an image, a plurality of touch electrodes that perform touch sensing, a plurality of touch lines that are connected to the plurality of touch electrodes and extend in a first direction, and a dummy touch line; and a touch driving circuit electrically connected to the plurality of touch electrodes through the plurality of touch lines, the touch driving circuit including at least one dummy touch terminal connected to the dummy touch line, wherein the dummy touch line includes a first portion and a second portion that extend in the first direction and a third portion that is connected to a first end of the first portion and a first end of the second portion, wherein the third portion of the dummy touch line extends in a second direction that intersects the first direction such that the third portion overlaps at least one of the plurality of touch lines.

According to one or more embodiments of the present disclosure, a touch display device may be provided that is capable of repairing a defect in a touch line by using a dummy touch line.

According to one or more embodiments of the present disclosure, a touch display device may be provided that is capable of repairing more effectively a defect in a touch line by using a dummy touch line with a loop shape.

According to one or more embodiments of the present disclosure, a touch display device may be provided that is capable of minimizing or reducing yield loss due to discarding of defective touch modules, optimizing the manufacturing process, and reducing manufacturing costs by effectively repairing a defect in a touch line.

Effects or advantages from aspects, examples, and embodiments described herein are not limited thereto, and additional effects or advantages will become apparent to those skilled in the art from the following description.

### BRIEF DESCRIPTION OF THE DRAWINGS

The accompanying drawings, which are included to provide a further understanding of the disclosure and are incorporated in and constitute a portion of the disclosure, illustrate aspects of the disclosure and together with the description serve to explain principles of the disclosure. It should be therefore understood that aspects, examples, and embodiments described herein are not limited to the illustrations of the accompanying drawings. In the drawings:

FIG. 1 is a system configuration of an example touch display device according to embodiments of the present disclosure;

FIG. 2 illustrates a configuration of an example subpixel included in the touch display device according to embodiments of the present disclosure;

FIG. 3 illustrates an example dummy touch line included in the touch display device according to embodiments of the present disclosure;

FIGS. 4 and 5 illustrate example configurations where a touch driving signal is supplied through a dummy touch line in a touch driving circuit according to embodiments of the present specification;

FIGS. 6 and 7 illustrate example structures where touch electrodes are configured in the touch display device according to embodiments of the present disclosure;

FIG. 8 illustrates an example configuration of a dummy touch line included in the touch display device according to embodiments of the present disclosure; and

FIG. 9 illustrates an example stack-up structure of a display panel according to embodiments of the present disclosure.

### DETAILED DESCRIPTION

Reference will now be made in detail to example embodiments of the present disclosure, examples or aspects of which may be illustrated in the accompanying drawings. In the following description, the structures, implementations, methods, and operations described herein are not limited to the specific examples, aspects, and embodiments set forth herein and may be changed as is known in the art, unless otherwise specified. Like reference numerals designate like elements throughout, unless otherwise specified. Names of the respective elements used in the following explanations are selected only for convenience of writing the specification and may thus be different from those used in actual products. Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments are provided so that this disclosure may be sufficiently thorough and complete to assist those skilled in the art to fully understand the scope of the present disclosure. Further, the protected scope of the present disclosure is defined by claims and their equivalents. In the following description, where the detailed description of the relevant known function or configuration may unnecessarily obscure aspects of the present disclosure, a detailed description of such known function or configuration may be omitted. The shapes, sizes, ratios, angles, numbers, and the like, which are illustrated in the drawings to describe various example embodiments of the present disclosure, are merely given by way of example. Therefore, the present disclosure is not limited to the illustrations in the drawings. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Although the terms “first,” “second,” A, B, (a), (b), and the like may be used herein to describe various elements, these elements should not be interpreted to be limited by these terms as they are not used to define a particular order or precedence. These terms are used only to distinguish one element from another. For example, a first element could be termed a second element, and, similarly, a second element could be termed a first element, without departing from the scope of the present disclosure.

When it is mentioned that a first element "is connected or coupled to", “contacts”, “ overlaps with”, or the like a second element, it should be interpreted that, not only can the first element “be directly connected or coupled to”, “directly contact”, or “directly overlap with” the second element, but a third element can also be "interposed" between the first and second elements, or the first and second elements can "be connected or coupled to", “contact”, “overlap with”, or the like each other via a fourth element. Here, the second element may be included in at least one of two or more elements that "are connected or coupled to", “contact”, “overlap with”, or the like each other.

Where positional relationships are described, for example, where the positional relationship between two parts is described using “on,” “over,” “under,” “above,” “below,” “beside,” “next,” or the like, one or more other parts may be located between the two parts unless a more limiting term, such as “immediate(ly),” “direct(ly),” or “close(ly)” is used. For example, where an element or layer is disposed “on” another element or layer, a third element or layer may be interposed therebetween. Furthermore, the terms “left,” “right,” “top,” “bottom, “downward,” “upward,” “upper,” “lower,” and the like refer to an arbitrary frame of reference.

In addition, when any dimensions, relative sizes etc. are mentioned, it should be considered that numerical values for an elements or features, or corresponding information (e.g., level, range, and the like) include a tolerance or error range that may be caused by various factors (e.g., process factors, internal or external impact, noise, and the like) even when a relevant description is not specified. Further, the term “may” fully encompasses all the meanings of the term “can”.

In the following description, various example aspects of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, aspects of the present disclosure are not limited to a scale, dimension, size, and thickness illustrated in the drawings.

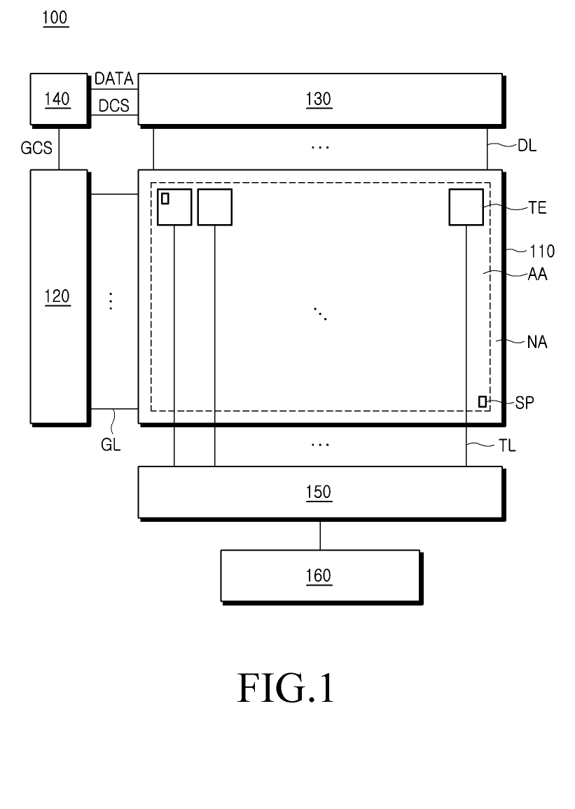

FIG. 1 is a system configuration of an example touch display device 100 according to aspects of the present disclosure.

Referring to FIG. 1, the touch display device 100 may include a display panel 110 in which a display area AA allowing a plurality of subpixels SP to be disposed and a non-display area NA located outside of the display area AA are defined.

The touch display device 100 may include a gate driving circuit 120, a data driving circuit 130, and a controller 140 for driving several signal lines disposed in the display panel 110.

A plurality of gate lines GL and a plurality of data lines DL may be disposed in the display panel 110, and a respective subpixel SP may be disposed in each of areas where the gate lines GL and the data lines DL intersect.

The gate driving circuit 120 may be controlled by the controller 140, and can control driving times of the plurality of subpixels SP by sequentially outputting gate signals to the plurality of gate lines GL disposed in the display panel 110.

For example, the gate driving circuit 120 can output at least one gate signal among a first scan gate signal, a second scan gate signal, and an emission control gate signal to each of the plurality of subpixels SP.

The gate driving circuit 120 may include one or more gate driver integrated circuits GDIC. The gate driving circuit 120 may be located on one side, or two or more sides, of the display panel 110 depending on design requirements.

Each gate driver integrated circuit GDIC may be connected to a bonding pad of the display panel 110 by a tape-automated-bonding (TAB) technique or a chip-on-glass (COG) technique, or be disposed in the display panel 110 by a gate-in-panel (GIP) technique. In one or more embodiments, each gate driver integrated circuit GDIC may be disposed such that it is integrated in the display panel 110. In one or more aspects, each gate driver integrated circuit GDIC may be mounted on a film connected to the display panel 110 by a chip-on-film (COF) technique.

In one or more embodiments, the gate driving circuit 120 may include a plurality of stages respectively corresponding to a plurality of gate lines GL, and each of the plurality of stages may include at least one scan driver and at least one emission control driver.

For example, the gate driving circuit 120 may include at least one first scan driver configured to supply a first scan gate signal, at least one second scan driver configured to supply a second scan gate signal, and at least one emission control driver configured to supply an emission control gate signal.

The data driving circuit 130 can receive image data DATA from the controller 140 and convert the image data DATA into an analog data voltage. The data driving circuit 130 can output a respective data voltage to each data line DL according to times at which scan signals are applied through gate lines GL, and thereby cause a corresponding subpixel SP to emit light at luminance according to the image data DATA.

The data driving circuit 130 may include one or more source driver integrated circuits SDIC.

Each source driver integrated circuit SDIC may include a shift register, a latch circuit, a digital-to-analog converter, an output buffer, and the like.

Each source driver integrated circuit SDIC may be connected to a bonding pad of the display panel 110 by the tape-automated-bonding (TAB) technique or the chip-on-glass (COG) technique, or may be directly placed on the display panel 110. In one or more aspects, each source driver integrated circuit SDIC may be disposed such that it is integrated in the display panel 110. In one or more aspects, each source driver integrated circuit SDIC may be implemented by the chip-on-film (COF) technique. In this implementation, each source driver integrated circuit SDIC may be mounted on a film connected to the display panel 110 and be electrically connected to the display panel 110 through lines on the film.

The controller 140 can supply several control signals to the gate driving circuit 120 and the data driving circuit (130), and can control operations of the gate driving circuit 120 and the data driving circuit 130.

The controller 140 may be mounted on a printed circuit board or a flexible printed circuit, and be electrically connected to the gate driving circuit 120 and the data driving circuit 130 through the printed circuit board or the flexible printed circuit.

The controller 140 can cause the gate driving circuit 120 to output gate signals according to times established in each frame. The controller 140 can convert image data received from an external device or system into a data signal form readable by the data driving circuit 130 and output the resulted image data to the data driving circuit 130.

The controller 140 can receive, in addition to image data, several types of timing signals including a vertical synchronous signal Vsync, a horizontal synchronous signal Hsync, an input data enable (DE) signal, a clock signal CLK, and the like from the external device or system (e.g., a host system).

The controller 140 can generate several control signals (DCS, GCS) using the timing signals received from the external device or system (e.g., the host system) and output the generated control signals (DCS, GCS) to the gate driving circuit 120 and the data driving circuit 130.

For example, to control the gate driving circuit 120, the controller 140 can output several gate control signals GCS including a gate start pulse (GSP), a gate shift clock (GSC), a gate output enable signal (GOE), and the like to the gate driving circuit 120.

For example, to control the data driving circuit 130, the controller 140 can output several data control signals DCS including a source start pulse (SSP), a source sampling clock (SSC), a source output enable signal (SOE), and the like to the data driving circuit 130.

The touch display device 100 may include a power management integrated circuit for supplying various voltages or currents to the display panel 110, the gate driving circuit 120, and the data driving circuit 130, or for controlling the various voltages or currents to be supplied.

In one or more embodiments, a liquid crystal or a light emitting element may be disposed in each subpixel SP depending on the type of the display panel 110. In one or more embodiments, an electrode to which a data voltage is applied and an electrode to which a common voltage is applied may be disposed in each, or one or more, subpixels SP disposed in the display panel 110.

In one or more embodiments, the touch display device 100 may include a touch sensor, lines, and at least one driving circuit for sensing a user's touch on the display panel 110.

For example, the touch display device 100 may include a plurality of touch electrodes TE located in the display area AA, a touch driving circuit 150 for driving the touch electrodes TE, and a plurality of touch lines TL for connecting the touch electrodes TE and the touch driving circuit 150 to each other. In one or more embodiments, the touch display device 100 may include a touch controller 160 for controlling the touch driving circuit 150 and detecting a touch based on a signal or data detected by the touch driving circuit 150.

The touch electrodes TE may be disposed on the display panel 110 or may be embedded into the display panel 110.

In an example where the touch electrodes TE are embedded into the display panel 110, a structure in which the touch electrodes TE are disposed in the display panel 110 may vary depending on types of the touch display device 100.

In one or more embodiments, in an example where the touch display device 100 has a top-emission structure, the touch electrodes TE may be disposed on an encapsulation part configured to protect one or more light emitting elements in the display panel 110.

In one or more embodiments, in an example where the touch display device 100 has a bottom-emission structure, the touch electrodes TE may be disposed between a layer in which one or more light emitting elements are disposed and a substrate.

In one or more embodiments, the touch electrodes TE may be formed by using portions of at least one of electrode layers included in one or more light emitting elements in the display panel 110.

In this implementation, the at least one electrode layer included in the one or more light emitting elements may provide the functions of electrodes for display driving and electrodes for touch sensing. In one or more aspects, an electrode layer for display driving and an electrode layer for touch sensing may be located in the same layer while being disposed to be spaced apart from each other.

For example, the touch electrodes TE may be transparent electrodes, or opaque electrodes whose respective one or more portions are opened.

For example, the touch electrodes TE formed to have opened portions may be touch electrodes TE configured to have a mesh with one or more openings. The opened portions of the touch electrodes TE may overlap with light emitting areas disposed respectively in subpixels SP.

In one or more embodiments, touch lines TL may be disposed such that a respective touch line TL may be connected to each touch electrode TE, or one touch line TL may be connected to a plurality of touch electrodes TE depending on structures in which touch electrodes TE are disposed and methods of touch sensing.

For example, as illustrated in FIG. 1, a plurality of touch electrodes TE may be disposed separately from each other, and a respective touch line TL may be electrically connected to each touch electrode TE.

In this example, the plurality of touch electrodes TE may be disposed in the same layer. In one or more embodiments, a plurality of touch lines TL may be disposed in a layer different from a layer in which touch electrodes TE are disposed. Each of the plurality of touch lines TL can be electrically connected to a respective one of the plurality of touch electrodes TE. A portion of a touch line TL may overlap with a touch electrode TE not electrically connected to the touch line TL.

For example, a touch driving signal can be supplied to a touch electrode TE through a touch line TL, and a touch can be sensed by detecting a change in self-capacitance detected through the touch line TL.

In another example, a plurality of touch electrodes TE may include a plurality of touch electrodes TE connected in a first direction and a plurality of touch electrodes TE connected in a second direction. Touch lines TL may be disposed such that a touch line TL is electrically connected to touch electrodes TE connected in the first direction, and another touch line TL is electrically connected to touch electrodes TE connected in the second direction.

In this implementation, the plurality of touch electrodes TE may be disposed in the same layer, or according to design requirements, some of the touch electrodes TE may be connected by at least one connection line disposed in the same layer as the touch electrodes TE, and the remaining touch electrodes TE may be connected by at least one connection line disposed in a layer different from the touch electrodes TE.

For example, the first direction may be the column direction (i.e., the Y-axis direction), and the second direction may be the row direction (i.e., the X-axis direction), but aspects of the present disclosure are not limited thereto. For example, the first direction may be the row direction and the second direction may be the column direction.

When touch sensing is performed, a touch driving signal may be applied to a plurality of touch electrodes TE connected in the first direction or the second direction, and a touch detection signal may be detected from at least one or more of the plurality of touch electrodes TE connected in the second direction or the first direction. In a situation where different signals are applied to touch electrodes TE connected in the first direction and touch electrodes TE connected in the second direction, a touch can be detected by detecting a change in mutual capacitance between the touch electrodes TE caused by the touch.

The touch driving circuit 150 can output a touch driving signal to touch electrodes TE through touch lines TL, and can detect a touch sensing signal from at least one or more of the touch electrodes TE.

In one or more embodiments, the touch driving circuit 150 may include, for example, an operational amplifier connected to touch lines TL for supplying a touch driving signal and receiving a touch sensing signal, and a feedback capacitor for accumulating charges corresponding to signals received by the operational amplifier. The touch driving circuit 150 may include an integrator, a sample and hold circuit, an analog-to-digital converter, and the like for processing one or more output signals of the operational amplifier.

The touch driving circuit 150 can convert a touch sensing signal detected by one or more touch electrodes TE into touch sensing data in digital form and provide the resulting touch sensing data to the touch controller 160. The touch controller 160 can detect the presence or absence of a touch, touch coordinates, and the like based on the touch sensing data received from the touch driving circuit 150.

The touch driving circuit 150 may be disposed in a separate circuit from the display panel 110, or may be implemented in an integrated circuit with the data driving circuit 130 or another circuit (or driver) depending on design requirements.

According to the foregoing configurations, even when a touch sensing function can be provided using touch electrodes TE disposed on or in the display panel 110, touch sensing or display driving may be affected due to parasitic capacitance between the touch electrodes TE and electrodes or signal lines for display driving.

To address this issue, in one or more embodiments, the touch driving circuit 150 may include at least one dummy touch terminal connected to a dummy touch line overlapping with a plurality of touch lines TL.

For example, the dummy touch line may be a loop-shaped line that extends in a second direction intersecting a first direction to overlap a plurality of touch lines TL extending in the first direction and is connected to at least one dummy touch terminal.

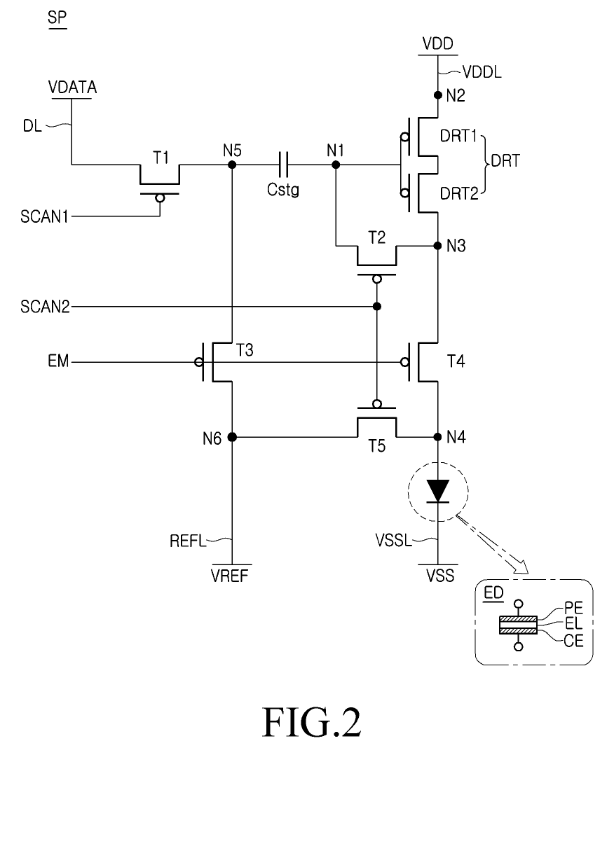

FIG. 2 illustrates a configuration of an example subpixel SP included in the touch display device 100 according to aspects of the present disclosure.

Referring to FIG. 2, a subpixel SP may include a light emitting element ED and a driving transistor DRT configured to drive the light emitting element ED.

The light emitting element ED may include a pixel electrode PE and a common electrode CE, and further include an emission layer EL located between the pixel electrode PE and the common electrode CE.

The pixel electrode PE of the light emitting element ED may be an electrode disposed for each subpixel SP, and the common electrode CE may be an electrode commonly disposed for all, or one or more, of subpixels SP.

For example, the pixel electrode PE may be an anode electrode and the common electrode CE may be a cathode electrode. In another example, the pixel electrode PE may be a cathode electrode and the common electrode CE may be an anode electrode.

The pixel electrode PE of the light emitting element ED may be connected to a fourth node N4, and the common electrode CE may be connected to a low voltage line VSSL for delivering a low voltage VSS.

For example, the light emitting element ED may be at least one of an organic light emitting diode (OLED), a light emitting diode (LED), or a quantum dot light emitting element.

The subpixel SP may further include one or more transistors in addition to the driving transistor DRT. For example, referring to FIG. 2, the subpixel SP may include first to fifth transistors (T1 to T5).

Referring to FIG. 2, the driving transistor DRT may include a first driving transistor DRT1 and a second driving transistor DRT2.

The driving transistor DRT may include a first node N1, a second node N2, and a third node N3. For example, the first node N1 may be respective gate nodes of the first driving transistor DRT1 and the second driving transistor DRT2, the second node N2 may be a source or drain node of the first driving transistor DRT1, and the third node N3 may be a drain or source node of the second driving transistor DRT2.

The drain or source node of the first driving transistor DRT1 may be connected to the source or drain node of the second driving transistor DRT2, and the first driving transistor DRT1 may be connected to a high voltage line VDDL for delivering a high voltage VDD through the second node N2.

The first transistor T1 can receive a first scan gate signal SCAN1 of a turn-on voltage level from the gate driving circuit 120, and control a connection between a data line DL for delivering a data voltage VDATA and a fifth node N5.

The first scan gate signal SCAN1 of the turn-on voltage level may be a signal of a high voltage level when the first transistor T1 is an n-type transistor, or be a signal of a low voltage level when the first transistor T1 is a p-type transistor.

The second transistor T2 can receive a second scan gate signal SCAN2 of a turn-on voltage level from the gate driving circuit 120 to control a connection between the first node N1 and the third node N3.

The fifth transistor T5 can receive the second scan gate signal SCAN2 of the turn-on voltage level from the gate driving circuit 120 to control a connection between the fourth node N4 and a sixth node N6.

The fifth transistor T5 may be connected to a reference voltage line REFL for delivering a reference voltage VREF through the sixth node N6, and can supply the reference voltage VREF to the fourth node N4 during a turn-on operation.

The second scan gate signal SCAN2 of the turn-on voltage level may be a signal of a high voltage level when the second transistor T2 and the fifth transistor T5 are n-type transistors, or be a signal of a low voltage level when the second transistor T2 and the fifth transistor T5 are p-type transistors.

The third transistor T3 can receive an emission control gate signal EM of a turn-on voltage level from the gate driving circuit 120, and control a connection between the fifth node N5 and the sixth node N6.

The fourth transistor T4 can receive the emission control gate signal EM of the turn-on voltage level from the gate driving circuit 120, and control a connection between the third node N3 and the fourth node N4.

The emission control gate signal EM of the turn-on voltage level may be a signal of a high voltage level when the third transistor T3 and the fourth transistor T4 are n-type transistors, or be a signal of a low voltage level when the third transistor T3 and the fourth transistor T4 are p-type transistors.

The subpixel SP may further include a storage capacitor Cstg, which is disposed between the first node N1 and the fifth node N5, and maintains a constant voltage during one frame.

Referring to FIG. 2, the first driving transistor DRT1, the second driving transistor DRT2, and the first to fifth transistors (T1 to T5) may be p-type transistors. However, aspects of the present disclosure are not limited thereto. For example, at least one of the first driving transistor DRT1, the second driving transistor DRT2, and the first to fifth transistors (T1 to T5) may be designed as an n-type transistor.

The first driving transistor DRT1, the second driving transistor DRT2, and the first to fifth transistors (T1 to T5) may be low-temperature polycrystalline silicon (LTPS) transistors. However, aspects of the present disclosure are not limited thereto. For example, at least one of the first driving transistor DRT1, the second driving transistor DRT2, and the first to fifth transistors (T1 to T5) may be designed as an oxide transistor.

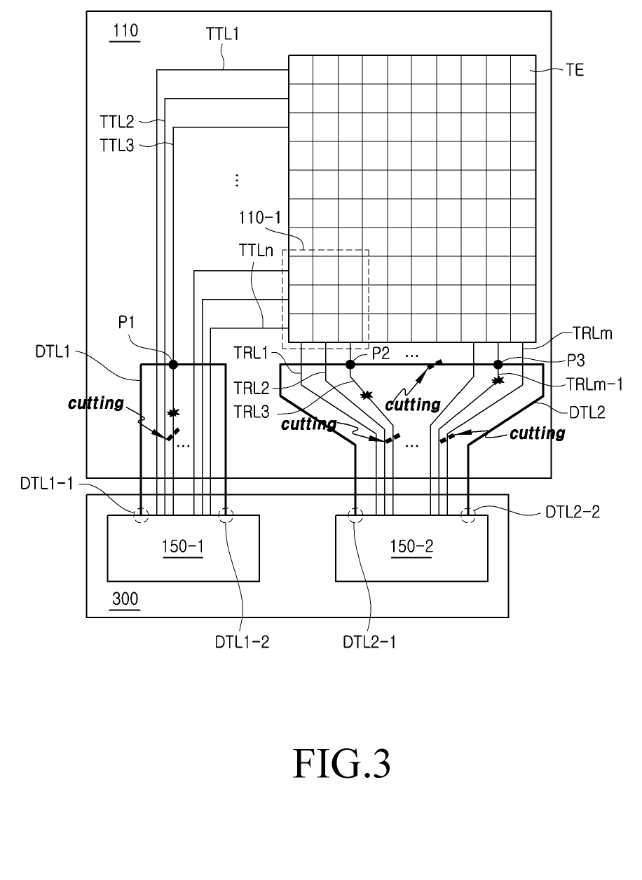

FIG. 3 illustrates at least one example dummy touch line (DTL1 and/or DTL2) included in the touch display device 100 according to aspects of the present disclosure.

Referring to FIG. 3, in one or more example embodiments, the touch driving circuit 150 may be mounted on a printed circuit board 300, and be connected to at least one dummy touch line having a loop shape through at least one dummy touch terminal. For example, a corresponding portion of the at least one dummy touch line may extend in a second direction (e.g., a row direction) to overlap with a plurality of touch lines TL extending in a first direction (e.g., a column direction).

In one or more embodiments, referring to FIG. 3, the touch driving circuit 150 may include a touch transmitting circuit 150-1 and a touch receiving circuit 150-2, and the at least one dummy touch line may include a first dummy touch line DTL1 and a second dummy touch line DTL2 that are each connected to the touch transmitting circuit 150-1. The first dummy touch line DTL1 and the second dummy touch line DTL2 are initially not connected to any touch electrode TE.

For example, the touch transmitting circuit 150-1 may be connected to a plurality of touch transmitting lines (TTL1 to TTLn, where n is a positive integer) among the plurality of touch lines TL, and be connected to the first dummy touch line DTL1 overlapping with the plurality of touch transmitting lines (TTL1 to TTLn) through at least one dummy touch transmitting terminal.

The touch receiving circuit 150-2 may be connected to a plurality of touch receiving lines (TRL1 to TRLm, where m is a positive integer) among the plurality of touch lines TL, and be connected to the second dummy touch line DTL2 overlapping with the plurality of touch receiving lines (TRL1 to TRLm) through at least one dummy touch receiving terminal.

Referring to FIG. 3, the first dummy touch line DTL1 may overlap with all of the plurality of touch transmitting lines (TTL1 to TTLn), and the second dummy touch line DTL2 may overlap with all of the plurality of touch receiving lines (TRL1 to TRLm). However, embodiments of the present disclosure are not limited thereto. For example, the first dummy touch line DTL1 may overlap with a portion of the plurality of touch transmitting lines (TTL1 to TTLn), and the second dummy touch line DTL2 may overlap with a portion of the plurality of touch receiving lines (TRL1 to TRLm).

In one or more embodiments, when the touch driving circuit 150 includes a first dummy touch terminal and a second dummy touch terminal, the first dummy touch terminal may be disposed on a first side (e.g., a left side) of the plurality of touch driving terminals, and the second dummy touch terminal may be disposed on a second side (e.g., a right side) of the plurality of touch driving terminals that is opposite the first side. However, embodiments of the present disclosure are not limited thereto.

For example, the touch transmitting circuit 150-1 may include first to nth touch transmitting terminals connected to the plurality of touch transmitting lines (TTL1 to TTLn), respectively. In this configuration, a first dummy touch transmitting terminal may be disposed at a location adjacent to (e.g., next to) the first touch transmitting terminal, and a second dummy touch transmitting terminal may be disposed at a location adjacent to (e.g., next to) the nth touch transmitting terminal.

For example, the touch receiving circuit 150-2 may include first to mth touch receiving terminals connected to the plurality of touch receiving lines (TRL1 to TRLm), respectively. In this configuration, a first dummy touch receiving terminal may be disposed at a location adjacent to the first touch receiving terminal, and a second dummy touch receiving terminal may be disposed at a location adjacent to the mth touch receiving terminal.

For example, both ends or edges of the dummy touch line may be connected to the same dummy touch terminal.

In one or more embodiments, one end or edge of the dummy touch line may be connected to the first dummy touch terminal, and the other end or edge of the dummy touch line may be connected to the second dummy touch terminal.

For example, each of a first end DTL1-1 and a second end DTL1-2 of the first dummy touch line DTL1 may be connected to any one of the first dummy touch transmitting terminal and the second dummy touch transmitting terminal. For example, the first end DTL1-1 of the first dummy touch line DTL1 may be connected to the first dummy touch transmitting terminal, and the second end DTL1-2 of the first dummy touch line DTL1 may be connected to the second dummy touch transmitting terminal. Thus, a first end of the first dummy touch line DTL1 is connected to the first dummy touch terminal and a second end of the first dummy touch line DTL1 is connected to the second dummy touch terminal.

For example, any of a first end DTL2-1 and a first end DTL2-2 of the second dummy touch line DTL2 may be connected to any one of the first dummy touch receiving terminal and the second dummy touch receiving terminal. For example, the first end DTL2-1 of the second dummy touch line DTL2 may be connected to the first dummy touch receiving terminal, and the first end DTL2-2 of the second dummy touch line DTL2 may be connected to the second dummy touch receiving terminal.

The dummy touch line may be electrically connected to any one of the plurality of touch lines TL within an area overlapping with the plurality of touch lines TL.

In one or more embodiments, referring to FIG. 3, the first dummy touch line DTL1 may be electrically connected to the third touch transmitting line TTL3 due to the third touch transmitting line TTL3 being defective. In this implementation, the third touch transmitting line TTL3 may be a line required to be repaired due to a line defect (such as being cut off, forming a short circuit, or the like) at at least one point within a portion of the third touch transmitting line TTL3 from a point P1 at which the third touch transmitting line TTL3 is connected to the first dummy touch line DTL1 to a third touch transmitting terminal where the third touch transmitting line TTL3 is connected to the touch transmitting circuit 150-1. Thus, a defective touch line includes a cut at a location that is disposed between a location where the defective touch line is connected to a dummy touch line and a location where the defective touch line is connected to a touch driving terminal in the touch driving circuit.

When the first dummy touch line DTL1 is connected to the third touch transmitting line TTL3, any one point within the portion of the third touch transmitting line TTL3 may be cut.

In this case, at least one touch electrode connected to the third touch transmitting line TTL3 among a plurality of touch electrodes TE can receive a touch driving signal that is supplied through one end DTL1-1 or the other end DTL1-2 of the first dummy touch line DTL1 and is delivered by the first dummy touch line DTL1 connected to the third touch transmitting line TTL3 at the connection point P1.

In one or more embodiments, the dummy touch line may be electrically connected to one touch line and another touch line among the plurality of touch lines TL in an area overlapping with the plurality of touch lines TL.

Referring to FIG. 3, the second dummy touch line DTL2 may be electrically connected to the third touch receiving line TRL3 that is defective and the (m-1)th touch receiving line TRLm-1 that is defective. In this implementation, the third touch receiving line TRL3 may be a line required to be repaired due to a line defect at at least one point within a portion of the third touch receiving line TRL3 from a point P2 at which the third touch receiving line TRL3 is connected to the second dummy touch line DTL2 to a third touch receiving terminal where the third touch receiving line TRL3 is connected to the touch receiving circuit 150-2. Similarly, the (m-1)th touch receiving line TRLm-1 may also be a line required to be repaired due to a line defect at at least one point within a portion of the (m-1)th touch receiving line TRLm-1 from a point P3 at which the (m-1)th touch receiving line TRLm-1 is connected to the second dummy touch line DTL2 to an (m-1)th touch receiving terminal where the (m-1)th touch receiving line TRLm-1 is connected to the touch receiving circuit 150-2.

When the second dummy touch line DTL2 is connected to the third touch receiving line TRL3 and the (m-1)th touch receiving line TRLm-1, any one point within the portion of the third touch receiving line TRL3 and any one point within the portion of the (m-1)th touch receiving line TRLm-1 may be cut.

In addition, the second dummy touch line DTL2 may be cut at any one point within a portion of the second dummy touch line DTL2 from the point P2 connected to the third touch receiving line TRL3 to the point P3 connected to the (m-1)th touch receiving line TRLm-1. Thus, the second dummy touch line DTL2 is cut at a location of the second dummy touch line DTL2 that is between the location P2 where the second dummy touch line DTL2 is connected to the third touch receiving line TRL3 and a location where the second dummy touch line DTL2 is connected to the (m-1)th touch receiving line TRLm-1 at location P3.

In this case, at least one touch electrode connected to the third touch receiving line TRL3 among the plurality of touch electrodes TE can transmit a touch detection signal to the touch receiving circuit 150-2 through one end DRL2-1 of the second dummy touch line DTL2, and at least one touch electrode connected to the (m-1)th receiving line TRLm-1 among the plurality of touch electrodes TE can transmit a touch detection signal to the touch receiving circuit 150-2 through the other end DRL2-2 of the second dummy touch line DTL2.

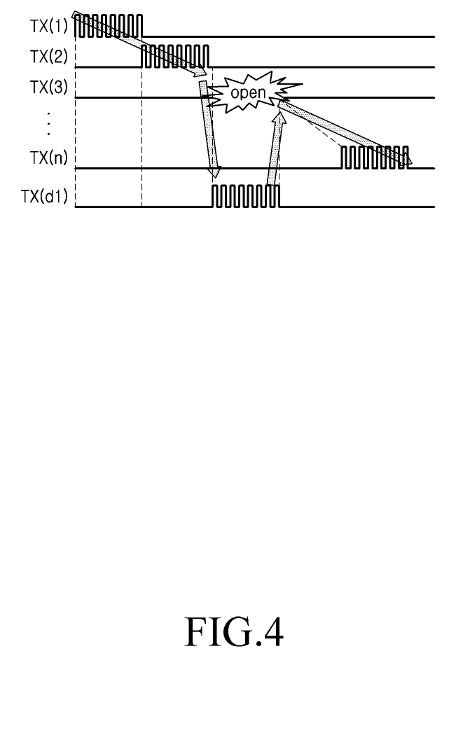

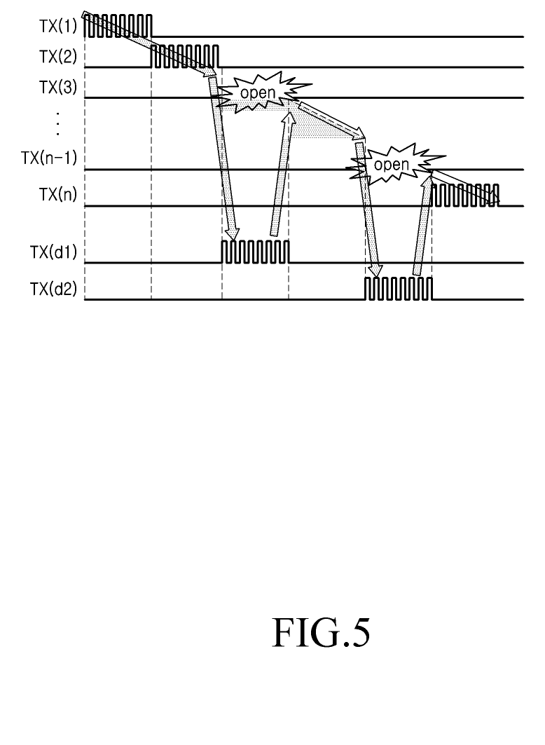

FIGS. 4 and 5 illustrate example configurations where a touch driving signal is supplied through a dummy touch line DTL in the touch driving circuit 150 according to embodiments of the present specification.

Referring to FIGS. 4 and 5, the touch transmitting circuit 150-1 of the touch driving circuit 150 may be connected to first to nth touch transmitting lines (TTL1 to TTLn) through first to nth touch transmitting terminals (Tx(1) to Tx(n)), respectively, and can sequentially supply touch driving signals to the first to nth touch transmitting lines (TTL1 to TTLn).

For example, the touch transmitting circuit 150-1 can determine a touch scanning order in advance, and control transmitting times of touch driving signals to the first to nth touch transmitting terminals (Tx(1) to Tx(n)) based on the determined touch scan order.

The touch receiving circuit 150-2 of the touch driving circuits 150 may be connected to first to mth touch receiving lines (TRL1 to TRLm) through first to mth touch receiving terminals, respectively, and can sequentially receive touch detection signals from the first to mth touch receiving lines (TRL1 to TRLm).

For example, the touch receiving circuit 150-2 can determine a touch scanning order in advance, and control receiving times of touch detection signals from the first to mth touch receiving terminals based on the determined touch scan order.

Referring to FIG. 4, the third touch transmitting line TTL3 among the first to nth touch transmitting lines (TTL1 to TTLn) may be electrically connected to a first dummy touch line DTL1 connected to a first dummy touch transmitting terminal Tx(d1) and can be repaired.

In this case, the touch transmitting circuit 150-1 can supply a touch driving signal through the first dummy touch transmitting terminal Tx(d1) instead of the third touch transmitting terminal Tx(3) at a time of supplying the touch driving signal through the third touch transmitting terminal Tx(3), and thereby supply the touch driving signal to at least one touch electrode connected to the third touch transmitting line TTL3. Thus, the touch transmitting circuit 150-1 is configured to apply a touch driving signal to the first dummy touch line DTL1 through a dummy touch terminal at a time corresponding to when the touch driving signal is supposed to be supplied to the defective touch line.

Referring to FIG. 5, among first to nth touch receiving lines (TRL1 to TRLn), the third touch receiving line TRL3 and the (n-1)th touch receiving line TRLn-1 may be electrically connected to a first dummy touch transmitting terminal Tx(d1) and a second dummy touch transmitting terminal Tx(d2), respectively, and can be repaired.

In this case, the touch receiving circuit 150-2 can receiving a touch sensing signal through the first dummy touch receiving terminal Tr(d1) instead of a third touch receiving terminal Tr(3) at a time of supplying the touch driving signal through the third touch transmitting terminal Tx(3), and receive a touch sensing signal through a second dummy touch receiving terminal Tr(d2) instead of the (n-1)th touch receiving terminal Tr(n-1) at a time of supplying the touch driving signal through the (n-1)th touch transmitting terminal Tx(n-1). Thereby, the touch receiving circuit 150-2 can receive the touch sensing signal to respective at least one touch electrode connected to the third touch transmitting line TTL3 and the (n-1)th touch transmitting line TTLn-1.

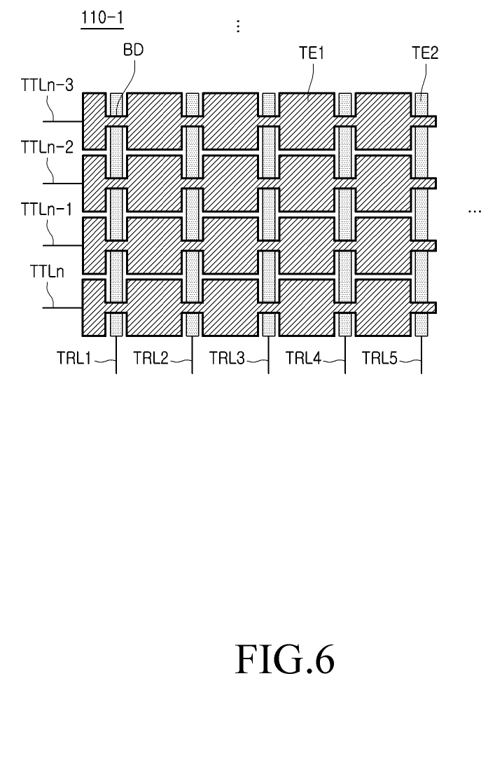

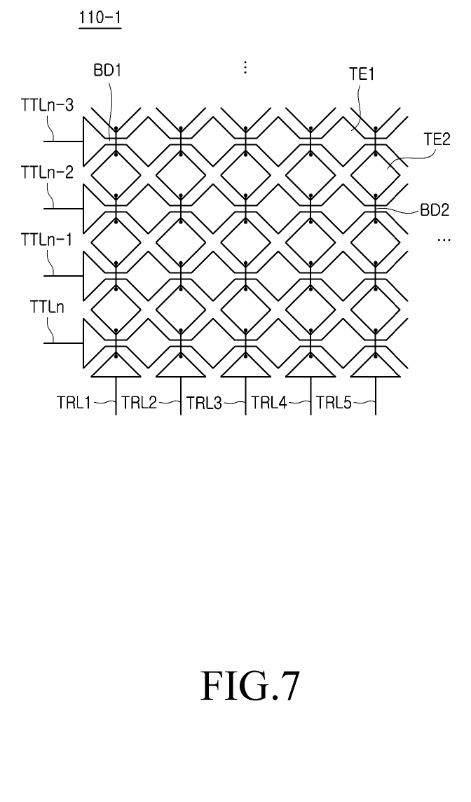

FIGS. 6 and 7 illustrate example structures where touch electrodes TE are configured in the touch display device 100 according to aspects of the present disclosure.

FIGS. 6 and 7 may be enlarged views of area 110-1 illustrated in FIG. 3. FIG. 6 illustrates a first example embodiment of touch electrodes TE according to embodiments of the present disclosure, and FIG. 7 illustrates a second example embodiment of touch electrodes TE according to aspects of the present disclosure.

Referring to FIG. 6, in one or more example embodiments, a plurality of touch electrodes TE disposed in the display panel 110 may include a plurality of touch transmitting electrodes TE1 and a plurality of touch receiving electrodes TE2.

The plurality of touch transmitting electrodes TE1 may extend in a second direction (e.g., a row direction), and each of the touch transmitting electrodes TE1 may be connected to at least one adjacent touch transmitting electrode via at least one bridge pattern BD. The bridge pattern BD may also be described as a bridge metal.

The plurality of touch receiving electrodes TE2 may extend in a first direction (e.g., a column direction) and may have a bar shape.

Referring to FIG. 6, each of first to mth touch receiving lines (TRL1 to TRLm) may be electrically connected to a corresponding one of the plurality of touch receiving electrodes TE2, and each of the plurality of touch receiving electrodes TE2 may overlap with at least one bridge pattern BD connecting a plurality of touch transmitting electrodes TE1.

Referring to FIG. 6, touch transmitting electrodes disposed in the same row among the plurality of touch transmitting electrodes TE1 may be connected through at least one bridge pattern BD, and thereby can receive a touch driving signal delivered through the same touch transmitting line.

For example, among the plurality of touch transmitting electrodes TE1, touch transmitting electrodes receiving a touch driving signal through the nth touch transmitting line TTLn may be connected to each other by at least one bridge pattern BD.

In one or more embodiments, a plurality of touch transmitting electrodes TE1 and a plurality of touch receiving electrodes TE2 may be disposed in different layers, and the plurality of touch transmitting electrodes TE1 and a plurality of bridge patterns BD may be disposed in the same layer.

In one or more embodiments, the plurality of touch transmitting electrodes TE1 and the plurality of touch receiving electrodes TE2 may be disposed in the same layer, and the plurality of bridge patterns BD may be disposed in a different layer from the plurality of touch transmitting electrodes TE1 and the plurality of touch receiving electrodes TE2 and can interconnect adjacent touch transmitting electrodes TE1 among the plurality of touch transmitting electrodes TE1.

Referring to FIG. 6, the plurality of touch transmitting electrodes TE1 may be designed to have a square shape, but embodiments of the present disclosure are not limited thereto. For example, the plurality of touch transmitting electrodes TE1 may be designed in various shapes including a rhombus, etc.

Referring to FIG. 7, a plurality of touch transmitting electrodes TE1 may extend in the second direction, and each of the plurality of touch transmitting electrodes TE1 may be connected to at least one adjacent touch transmitting electrode through at least one first bridge pattern BD1.

A plurality of touch receiving electrodes TE2 may extend in the first direction, and each of the plurality of touch receiving electrodes TE2 may be connected to at least one adjacent touch receiving electrode through at least one second bridge pattern BD2. Each of the first bridge pattern BD1 and the second bridge pattern BD2 may be referred to as a bridge metal layer.

Referring to FIG. 7, touch transmitting electrodes disposed in the same row among the plurality of touch transmitting electrodes TE1 may be connected through at least one of a plurality of first bridge patterns BD1, and thereby can receive a touch driving signal from the same touch transmitting line. Further, touch receiving electrodes disposed in the same column among the plurality of touch receiving electrodes TE2 may be connected through at least one of a plurality of second bridge patterns BD2, and thereby can transmit a touch detection signal to the same touch receiving line.

For example, touch transmitting electrodes receiving a touch driving signal through an nth touch transmitting line TTLn among the plurality of touch transmitting electrodes TE1 may be connected to each other through at least one of the plurality of first bridge patterns BD1, and touch receiving electrodes transmitting a touch detection signal to an mth touch receiving line TRLm among the plurality of touch receiving electrodes TE2 may be connected to each other through at least one of the plurality of second bridge patterns BD2.

In one or more embodiments, the plurality of touch transmitting electrodes TE1 and the plurality of touch receiving electrodes TE2 may be disposed in the same layer, and the plurality of first bridge patterns BD1 and the plurality of second bridge patterns BD2 may be disposed in different layers.

For example, the plurality of first bridge patterns BD1 may be disposed in the same layer as the plurality of touch transmitting electrodes TE1 and the plurality of touch receiving electrodes TE2, and the plurality of second bridge patterns BD2 may be disposed in a layer different from the plurality of touch transmitting electrodes TE1 and the plurality of touch receiving electrodes TE2.

In another example, the plurality of first bridge patterns BD1 may be disposed in a layer different from the plurality of touch transmitting electrodes TE1 and the plurality of touch receiving electrodes TE2, and the plurality of second bridge patterns BD2 may be disposed in the same layer from the plurality of touch transmitting electrodes TE1 and the plurality of touch receiving electrodes TE2.

Referring to FIG. 7, the plurality of touch transmitting electrodes TE1 and the plurality of touch receiving electrodes TE2 may have a rhombus shape, but aspects of the present disclosure are not limited thereto. For example, the plurality of touch transmitting electrodes TE1 may have various shapes including a square shape.

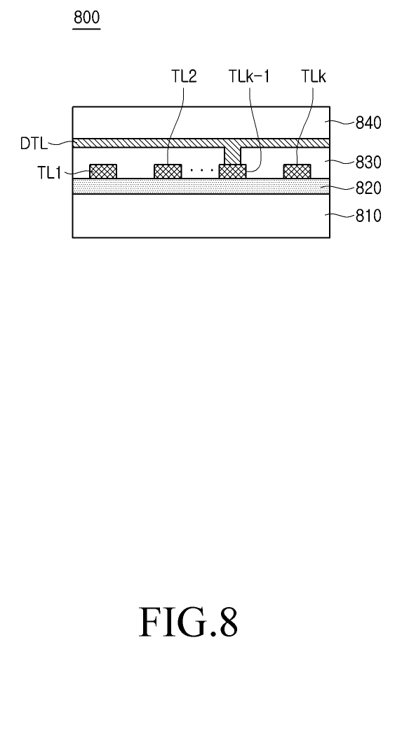

FIG. 8 illustrates an example configuration of a dummy touch line DTL included in the touch display device 100 according to aspects of the present disclosure.

Referring to FIG. 8, the dummy touch line DTL may be disposed in a layer different from a plurality of touch lines (TL1 to TLk, where k is a positive integer).

For example, when the dummy touch line DTL is a first dummy touch line DTL1, the plurality of touch lines (TL1 to TLk) may be touch transmitting lines (TTL1 to TTLn). Further, when the dummy touch line DTL is a second dummy touch line DTL2, the plurality of touch lines (TL1 to TLk) may be touch receiving lines (TRL1 to TRLm).

Referring to FIG. 8, in one or more embodiments, the display panel 110 may include a touch sensor layer 800, and the touch sensor layer 800 may include at least one metal layer for forming a plurality of touch electrodes TE and a plurality of touch line TL, and two or more insulating layers.

The two or more insulating layers included in the touch sensor layer 800 may include a touch buffer layer 810, a first touch insulating layer 820, a second touch insulating layer 830, a touch planarization layer 840, and the like.

For example, the touch buffer layer 810 may be an inorganic insulating layer or an organic insulating layer. Each of the first touch insulating layer 820 and the second touch insulating layer 830 may be an inorganic insulating layer or an organic insulating layer. The first touch insulating layer 820 and the second touch insulating layer 830 may also be referred to as a first touch interlayer insulating layer and a second touch interlayer insulating layer. The touch planarization layer 840 may be an organic insulating layer or an inorganic insulating layer, and may also be referred to as a touch protection layer.

The at least one metal layer included in the touch sensor layer 800 may include at least one of a first metal layer disposed between the touch buffer layer 810 and the first touch insulating layer 820, a second metal layer disposed between the first touch insulating layer 820 and the second touch insulating layer 830, and a third metal layer disposed between the second touch insulating layer 830 and the touch planarization layer 840.

The plurality of touch electrodes TE may be disposed in at least one of the first to third metal layers. The plurality of touch lines TL may be disposed in at least one of the first to third metal layers.

For example, each of the plurality of touch electrodes TE may include sensor metals serving as a touch sensor and bridge metals connecting the sensor metals. The sensor metals may be disposed in a sensor metal layer, and the bridge metals may be disposed within a bridge metal layer. The sensor metal layer may be one of the first to third metal layers (e.g., the second metal layer or the third metal layer), and the bridge metal layer may be another of the first to third metal layers (e.g., the first metal layer or the second metal layer).

A dummy touch line DTL may be disposed on the plurality of touch lines (TL1 to TLk). For example, the dummy touch line DTL may be disposed in a metal layer different from the plurality of touch lines TL. For example, the dummy touch line DTL may be disposed in the same metal layer as the plurality of touch electrodes TE. In another example, the dummy touch line DTL may be disposed in a metal layer different from the plurality of touch electrodes TE.

In one or more aspects, the dummy touch line DTL may be disposed in a metal layer disposed at a higher location than the plurality of touch lines (TL1 to TLk).

In one or more embodiments, the dummy touch line DTL may be disposed in the non-display area NA and not be disposed in the display area AA.

For example, as illustrated in FIG. 8, the second touch insulation layer 830 may be disposed between the dummy touch line DTL and the plurality of touch lines (TL1 to TLk). At least a portion of the dummy touch line DTL may overlap with at least a portion of the plurality of touch lines (TL1 to TLk) or at least one or more of the plurality of touch lines (TL1 to TLk).

In one or more aspects, the dummy touch line DTL may be electrically connected to a (k-1)th touch line TLK-1 among the plurality of touch lines (TL1 to TLk). For example, during a repair process in the panel manufacturing process, the dummy touch line DTL may be electrically connected to the (k-1)th touch line TLK-1 through a welding process based on laser melting.

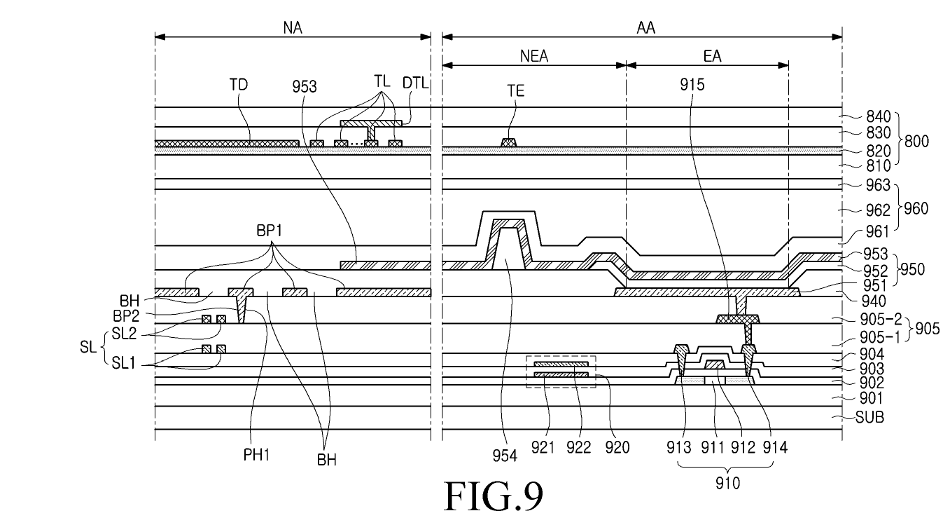

FIG. 9 illustrates an example stack-up structure of the display panel 110 according to aspects of the present disclosure.

Referring to FIGS. 8 and 9, in one or more example embodiments, the display panel 110 may include a substrate SUB in which a display area AA and a non-display area NA are defined, a plurality of insulating layers are disposed on the substrate SUB, and a light emitting element layer 950 disposed on the plurality of insulating layers.

For example, the plurality of insulating layers may include a buffer layer 901, a first insulating layer 902, a second insulating layer 903, a third insulating layer 904, and a planarization layer 905.

At least one transistor 910 included in a subpixel SP and the light emitting element layer 950 may be disposed in the display area AA of the substrate SUB, and a touch sensor layer 800 may be disposed on the light emitting element layer 950. An encapsulation layer 960 may be disposed between the light emitting element layer 950 and the touch sensor layer 800.

A plurality of signal lines SL for applying signals for display driving or supplying voltages may be disposed in the non-display area NA of the substrate SUB.

For example, the signal lines SL may be lines included in the gate driving circuit 120, and the signal lines SL can deliver signals supplied from a pad part to a scan driver or an emission control driver in the gate driving circuit 120. For example, the signal lines SL may be clock lines.

The touch sensor layer 800 may include a plurality of touch electrodes TE, a plurality of touch lines TL connected to the plurality of touch electrodes TE, and a dummy touch line DTL overlapping with the plurality of touch lines TL in the non-display area NA.

In one or more aspects, at least one blocking pattern may be disposed between the signal lines SL and the touch lines.

Signal lines SL may be disposed not to overlap with touch lines TL to prevent or reduce noise that may be caused when detecting touch detection signals through the touch lines TL. The signal lines SL may include at least one first signal line SL1 and at least one second signal line SL2, which are disposed in different layers.

The blocking pattern may be disposed to surround the display area AA, and in one or more aspects, at least a portion of the blocking pattern may extend beyond a boundary of the display area AA and be disposed inside of the display area AA. In one or more aspects, the blocking pattern may be disposed outside of the display area AA, and be spaced apart from the boundary of the display area AA.

The blocking pattern may include a first blocking pattern BP1 and a second blocking pattern BP2.

The blocking pattern may be a blocking layer including the first blocking pattern BP1 and a plurality of blocking pattern holes BH. The plurality of blocking pattern holes BH may be disposed to prevent or reduce degradation of the light emitting element layer 950 due to an out-gassing phenomenon occurring in the planarization layer 905.

The second blocking pattern BP2 may be a portion resulting from extending of the first blocking pattern BP1 in a vertical direction. Since the second blocking pattern BP2 is disposed between at least one signal line SL and at least one touch line, the influence of noise caused by the signal line SL on the touch line can be reduced.

In one or more aspects, a dummy touch pattern TD may be further disposed in a portion of the non-display area NA of the substrate SUB. The dummy touch pattern TD may be disposed between the touch line TL and an outer edge (or an end) of the substrate SUB.

In one or more aspects, the dummy touch pattern TD may be insulated from the plurality of touch line TL and the plurality of touch electrodes TE. For example, a constant voltage may be applied to the dummy touch pattern TD. The dummy touch pattern TD can distribute noise caused by parasitic capacitance formed by signal lines SL of a gate driver, and thereby reduce noise caused by the signal lines SL.

Hereinafter, a cross-sectional structure of the display panel 110 is discussed in more detail with reference to FIG. 9, but features of the display panel 110 according to aspects of the present disclosure are not limited to the illustration of FIG. 9.

Referring to FIG. 9, the substrate SUB can support various components of the touch display device 100. The substrate SUB may include glass or a plastic material having flexibility.

For example, the substrate SUB may include at least one of polyimide (PI), polymethylmethacrylate (PMMA), polyethylene terephthalate (PET), polyethersulfone, and polycarbonate, but aspects of the present disclosure are not limited thereto.

When the substrate SUB includes polyimide, the substrate SUB may be in the form of two polyimides. For example, an inorganic film may be further disposed between the two polyimides.

The buffer layer 901 may be disposed on the substrate SUB. The buffer layer 901 may include an insulating inorganic material such as silicon nitride (SiNx) or silicon oxide (SiOx), or may include an insulating organic material. However, aspects of the present disclosure are not limited thereto.

The buffer layer 901 may be in the form of a single layer of silicon nitride (SiNx) or silicon oxide (SiOx), or a multilayer thereof. In an example where the buffer layer 901 includes multiple layers, silicon oxide (SiOx) and silicon nitride (SiNx) may be formed alternately.

The buffer layer 901 may be omitted depending on the type and material of the substrate SUB, the structure and type of the transistor, and the like.

At least one transistor 910 may be disposed on the buffer layer 901. The at least one transistor 910 may include a semiconductor pattern 911, a gate electrode 912, a first electrode 913, and a second electrode 914. For example, the first electrode 913 may be a source or drain electrode, and the second electrode 914 may be the drain or source electrode.

For example, the at least one transistor 910 illustrated in FIG. 9 may be at least one of the fourth transistor T4 and the fifth transistor T5 included in the subpixel SP of FIG. 2.

For example, the semiconductor pattern 911 of the at least one transistor 910 may be disposed on the buffer layer 901.

The semiconductor pattern 911 may include a polycrystalline semiconductor. For example, the polycrystalline semiconductor may include a low-temperature polycrystalline silicon (LTPS) having the characteristic of high mobility, but aspects of the present disclosure are not limited thereto.

In another example, the semiconductor pattern 911 may include an oxide semiconductor. For example, the semiconductor pattern 911 may include one of indium-gallium-zinc-oxide (IGZO), indium-zinc-oxide (IZO), indium-gallium-tin-oxide (GTO), and indium-gallium-oxide (IGO), but aspects of the present disclosure are not limited thereto. In an example where the semiconductor pattern 911 includes an oxide semiconductor, the effect of blocking leakage current can be excellent, and thereby, a change in luminance of subpixels during low-speed driving can be minimized or reduce.

In an example where the semiconductor pattern 911 includes a polycrystalline semiconductor or an oxide semiconductor, a portion of the semiconductor pattern 911 may be a conductivity-enabled area.

The semiconductor pattern 911 may also include amorphous silicon (a-Si), or include various organic semiconductor materials such as pentacene, and the like. However, aspects of the present disclosure are not limited thereto.

The first insulating layer 902 may be disposed on the semiconductor pattern 911. The first insulating layer 902 may be disposed between the semiconductor pattern 911 and the gate electrode 912 and can insulate the semiconductor pattern 911 and the gate electrode 912 from each other.

The first insulating layer 902 may include an insulating inorganic material such as silicon nitride (SiNx), silicon oxide (SiOx), or the like, or include an insulating organic material. However, aspects of the present disclosure are not limited thereto.

The first insulating layer 902 may have holes to electrically connect each of the first electrode 913 and the second electrode 914 to the semiconductor pattern 911.

The gate electrode 912 of the at least one transistor 910 may be disposed on the first insulating layer 902. The gate electrode 912 may be disposed to overlap with the semiconductor pattern 911.

The first insulating layer 902 may include an insulating inorganic material such as silicon nitride (SiNx), silicon oxide (SiOx), or the like, or include an insulating organic material. However, aspects of the present disclosure are not limited thereto.

The second insulating layer 903 may be disposed on the gate electrode 912. The second insulating layer 903 may be disposed between the gate electrode 912 and the first and second electrodes (913 and 914), and thereby can insulate the gate electrode 912 and the first and second electrodes (913 and 914) from each other.

The second insulating layer 903 may have holes to electrically connect each of the first electrode 913 and the second electrode 914 to the semiconductor pattern 911.

The second insulating layer 903 may include an insulating inorganic material such as silicon nitride (SiNx), silicon oxide (SiOx), or the like, or include an insulating organic material. However, aspects of the present disclosure are not limited thereto.

In one or more aspects, a first capacitor electrode 921 of a storage capacitor 920 may be disposed on the first insulating layer 902, and a second capacitor electrode 922 of the storage capacitor 920 may be disposed on the second insulating layer 903. The first capacitor electrode 921 and the second capacitor electrode 922 may be disposed to overlap with each other.

The third insulating layer 904 may be disposed on the second insulating layer 903. The third insulating layer 904 may be disposed between the gate electrode 912 and the first and second electrodes (913 and 914), and thereby can insulate the gate electrode 912 and the first and second electrodes (913 and 914) from each other.

The third insulating layer 904 may include an insulating inorganic material such as silicon nitride (SiNx), silicon oxide (SiOx), or the like, or include an insulating organic material. However, aspects of the present disclosure are not limited thereto.

The third insulating layer 904 may have holes to electrically connect each of the first and second electrodes (913 and 914) to the semiconductor pattern 911.

The first and second electrodes (913 and 914) may be disposed on the third insulating layer 904.

The first and second electrodes (913 and 914) may be electrically connected to the semiconductor pattern 911 through holes of the first insulating layer 902, the second insulating layer 903, and the third insulating layer 904.

In one or more embodiments, a first signal line SL1 among the signal lines SL may be disposed on the third insulating layer 904 in the non-display area NA. The first signal line SL1 may be a single signal line or include at least two or more signal lines. When the first signal line SL1 includes at least two or more signal lines, these signal lines may be disposed to be spaced apart from each other.

In one or more embodiments, a high voltage line VDD and a low voltage line VSS may be disposed on the third insulating layer 904. The high voltage line VDD can deliver a high voltage. The low voltage line VSS can deliver a low voltage.

The planarization layer 905 may be disposed on the first electrode 913, the second electrode 914, and the first signal line SL1.

The planarization layer 905 can protect at least one transistor 910 disposed under the planarization layer 905, and can reduce or flatten a step difference by various patterns.

The planarization layer 905 may be in the form of a single layer, or include two or more layers considering the configuration of the electrodes.

As display devices providing a high resolution have become increasingly prevalent, various signal lines disposed in the display device 100 may be increased, and considering that it may be difficult to dispose all lines in one layer while maintaining a minimum distance between the lines, the signal lines may be designed to be disposed in two or more layers. Such an additional layer can provide room for line arrangement, and therefore, the display device 100 can provide an advantage of arranging lines and electrodes more easily or effectively. In an example where the planarization layer 905 configured with a multilayer includes a dielectric material, the planarization layer 905 can be used as usage for forming capacitance between metal layers.

When the planarization layer 905 includes two layers, the planarization layer 905 may include a first planarization layer 905-1 and a second planarization layer 905-2.

In one or more aspects, a second signal line SL2 among the signal lines SL may be disposed between the first planarization layer 905-1 and the second planarization layer 905-2 in the non-display area NA. The second signal line SL2 may be a single signal line or include at least two or more signal lines. In an example where the second signal line SL2 includes at least two or more signal lines, the second signal line SL2 may be disposed to be spaced apart from each other.

The first planarization layer 905-1 may have a hole, and a connection electrode 915 may be disposed in the hole. The second planarization layer 905-2 having a hole may be disposed on the first planarization layer 905-1 and the connection electrode 915. A pixel electrode 951 may be disposed in the hole of the second planarization layer 905-2. Therefore, the at least one transistor 910 and the pixel electrode 951 can be electrically connected through the connection electrode 915.

One end (or a portion) of the connection electrode 915 may be connected to the transistor 910, and the other end (or another portion) of the connection electrode 915 may be connected to the pixel electrode 951.

The light emitting element layer 950 may be disposed on the planarization layer 905. The light emitting element layer 950 may include the pixel electrode 951, an emission layer 952, and a common electrode 953.

For example, the pixel electrode 951 may be disposed on the planarization layer 905, and a bank 940 may be disposed on the planarization layer 905 to partially overlap with the pixel electrode 951.

The bank 940 can define a plurality of subpixels SP, minimize or reduce light bleeding, and prevent or reduce color mixing that may occur at various viewing angles.

The bank 940 can define (or distinguish) a light emitting area EA where light can be emitted and a non-light emitting area NEA where light cannot be emitted, and the bank 940 may be disposed in the non-light emitting area NEA. The bank 940 may have a bank hole for exposing the light emitting area and the pixel electrode 951. The bank 940 may include at least one material among an inorganic insulating material such as silicon nitride (SiNx) or silicon oxide (SiOx), an organic insulating material such as BenzoCycloButene (BCB), an acrylic resin, an epoxy resin, a phenolic resin, a polyamide resin, or a polyimide resin, or a photosensitive agent including a black pigment. However, aspects of the present disclosure are not limited thereto.

The bank 940 may be transparent, or be configured with black, or one or more other colors. The bank 940 may be disposed such that it covers one or more ends of the pixel electrode 951.

At least one spacer 954 may be disposed on the bank 940. The spacer 954 can prevent or reduce damage to the light emitting element layer 950 and minimize or reduce damage to the display device 100 from external impact. The spacer 954 may include the same material as the bank 940. The spacer 954 may be formed simultaneously with the bank 940 or be formed in a separate process. A height of the spacer 954 may be greater than a height of the bank 940.

The emission layer 952 may be disposed on the pixel electrode 951 and the bank 940. The emission layer 952 may include one of a red organic emission layer, a green organic emission layer, a blue organic emission layer, and a white organic emission layer to emit light of a specific color in each subpixel SP. In an example where the emission layer 952 includes a white organic emission layer, a color filter may be disposed on the emission layer 952 to convert white light from the white organic emission layer into light of a different color.

The light emitting element layer 950 may further include a hole injection layer, a hole transport layer, an electron transport layer, and an electron transport layer, which are disposed on or under the emission layer 952. However, aspects of the present disclosure are not limited thereto.

A respective emission layer 952 may be disposed in each subpixel SP, and the hole injection layer, the hole transport layer, the electron transport layer, and the electron transport layer may be disposed in all or at least a portion of the display area AA.

A plurality of emission layers 952 may be disposed for each subpixel SP. In this implementation, a charge generation layer may be disposed between two or more emission layers 952.

The common electrode 953 may be disposed on the emission layer 952. The common electrode 953 may be disposed such that it extends from the display area AA to the non-display area NA. A portion of the common electrode 953 extending to the non-display area NA may overlap with the first blocking pattern BP1 or a plurality of touch lines TL.

The common electrode 953 can supply electrons to the light emitting element layer 950 and may include a conductive material having a low work function.

Referring to FIG. 9, an area where the pixel electrode 951, the emission layer 952, and the common electrode 953 overlap with each other may be a light emitting area EA.

The encapsulation layer 960 may be disposed on the common electrode 953. The encapsulation layer 960 can protect the light emitting element layer 950 from external moisture, oxygen, or undesired substances. For example, the encapsulation layer 960 can prevent or reduce the penetration of oxygen and moisture from the outside into a material of the emission layer 952 and materials of the pixel electrode 951 and the common electrode 953, and prevent or reduce oxidation of these materials.

The encapsulation layer 960 may include a transparent material to allow light emitted from the emission layer to be transmitted.

The encapsulation layer 960 may include a first encapsulation layer 961, a second encapsulation layer 962, and a third encapsulation layer 963. The encapsulation layer 960 may have a structure where the first encapsulation layer 961, the second encapsulation layer 962, and the third encapsulation layer 963 are alternately stacked.

The first encapsulation layer 961 and the third encapsulation layer 963 may include at least one or more inorganic materials selected from silicon nitride (SiNx), silicon oxide (SiOx), and aluminum oxide (AlyOz). However, aspects of the present disclosure are not limited thereto. The first encapsulation layer 961 and the third encapsulation layer 963 may be formed using a vacuum film forming method such as chemical vapor deposition (CVD) or atomic layer deposition (ALD), but aspects of the present disclosure are not limited thereto.

Each of the first encapsulation layer 961 and the third encapsulation layer 963 may be in the form of at least two or more layers. For example, the first encapsulation layer 961 may include a three-layer structure of silicon oxide (SiOx), silicon nitride (SiNx), and silicon oxide (SiOx), but aspects of the present disclosure are not limited thereto. For example, the first encapsulation layer 961 may include a four-layer structure of silicon oxide (SiOx), silicon nitride (SiNx), silicon oxide (SiOx), and silicon oxide (SiOx), but aspects of the present disclosure are not limited thereto.

The second encapsulation layer 962 may cover undesired substances or particles that may occur during the manufacturing process. In one or more aspects, the second encapsulation layer 962 can flatten the surface of the first encapsulation layer 961. For example, the second encapsulation layer 962 may be a particle cover layer, but aspects of the present disclosure are not limited thereto.

The second encapsulating layer 962 may be an organic material, for example, a polymer such as silicon oxycarbon (SiOCz) epoxy, polyimide, polyethylene, or acrylate, but aspects of the present disclosure are not limited thereto.

The second encapsulating layer 962 may include a thermosetting material or a photocurable material, which can be cured by heat or light.

The touch sensor layer 800 may be disposed on the encapsulating layer 960. The touch sensor layer 800 may include a touch buffer layer 810, a first touch insulating layer 820 on which a plurality of touch lines TL and a plurality of touch electrodes TE are disposed, a second touch insulating layer 830 on which a dummy touch line DTL is disposed, and a touch planarization layer 840.

For example, the touch buffer layer 810 may be disposed on the encapsulating layer 960. The touch buffer layer 810 can block a chemical solution (developing solution, etching solution, or the like) used in the manufacturing process of the touch sensor layer 800 or moisture from the outside from penetrating into the light emitting element layer 950 including an organic substance.

Further, the touch buffer layer 810 can prevent or reduce a situation where a plurality of touch sensor metals disposed on the touch buffer layer 810 form a short circuit due to external impact, and block interference signals that may occur when the touch sensor layer is driven.

The first touch insulation layer 820 may be disposed on the touch buffer layer 810, and the second touch insulation layer 830 may be disposed on the first touch insulation layer 820. In one or more aspects, at least one touch line among the plurality of touch lines TL disposed on the first touch insulation layer 820 may be electrically connected to a dummy touch line DTL disposed on the second touch insulation layer 830.

The touch planarization layer 840 may be disposed on the second touch insulation layer 830. The touch planarization layer 840 can protect the touch electrodes TE and the touch lines TL disposed thereunder, and can reduce or flatten a step difference caused by electrodes disposed in the display area AA.

For example, the touch planarization layer 840 may include at least one of an acrylic resin, an epoxy resin, a phenol resin, a polyamide resin, a polyimide resin, an unsaturated polyester resin, a polyphenylene resin, and a polyphenylene sulfide resin, but aspects of the present disclosure are not limited thereto.

The examples, aspects, and embodiments for the display device 100 and the display panel 110 described herein may be described as follows.

In one embodiment, a touch display device comprises: a display panel comprising a plurality of subpixels that display an image, a plurality of touch electrodes that perform touch sensing, a plurality of touch lines that are connected to the plurality of touch electrodes, and a dummy touch line; and a touch driving circuit electrically connected to the plurality of touch electrodes through the plurality of touch lines, the touch driving circuit including at least one dummy touch terminal connected to the dummy touch line, wherein the dummy touch line overlaps the plurality of touch lines.

In one embodiment, the plurality of touch lines extend in a first direction and the dummy touch line has a loop shape including a portion that extends in a second direction that intersects the first direction such that the portion of the loop shape overlaps the plurality of touch lines.

In one embodiment, both ends of the dummy touch line are connected to a same dummy touch terminal from the at least one dummy touch terminal.

In one embodiment, a first end of the dummy touch line is connected to a first dummy touch terminal from the at least one dummy touch terminal and a second end of the dummy touch line is connected to a second dummy touch terminal from the at least one dummy touch terminal.

In one embodiment, the touch driving circuit comprises a plurality of touch driving terminals connected to the plurality of touch lines, and wherein the first dummy touch terminal is disposed on a first side of the plurality of touch driving terminals and the second dummy touch terminal is disposed on a second side of the plurality of touch driving terminals that is opposite the first side.

In one embodiment, the dummy touch line is electrically connected to one touch line among the plurality of touch lines at an area overlapping with the plurality of touch lines.

In one embodiment, the one touch line includes a cut at a location that is disposed between a location where the one touch line is connected to the dummy touch line and a location where the one touch line is connected to one touch driving terminal in the touch driving circuit.

In one embodiment, the touch driving circuit is configured to apply a touch driving signal to the dummy touch line through the at least one dummy touch terminal at a time corresponding to when the touch driving signal is supposed to be supplied to the one touch line.

In one embodiment, the dummy touch line is electrically connected to another touch line among the plurality of touch lines in the area overlapping with the plurality of touch lines.

In one embodiment, the dummy touch line is cut at a location of the dummy touch line that is between the location where the dummy touch line is connected to the one touch line and a location where the dummy touch line is connected to the other touch line.

In one embodiment, the other touch line is cut at a location that is disposed between the location where the dummy touch line is connected to the other touch line and a location where the other touch line is electrically connected to another touch driving terminal in the touch driving circuit.

In one embodiment, the touch driving circuit is configured to apply a touch driving signal to the dummy touch line through the at least one dummy touch terminal at a time corresponding to when the touch driving signal is supposed to be supplied to the other touch line.

In one embodiment, the touch driving circuit comprises: a touch transmitting circuit connected to a plurality of touch transmitting lines among the plurality of touch lines, the touch transmitting circuit comprising at least one dummy touch transmitting terminal from the at least one dummy touch terminal that is connected to a first dummy touch line from the dummy touch line that overlaps the plurality of touch transmitting lines; and a touch receiving circuit connected to a plurality of touch receiving lines among the plurality of touch lines, the touch receiving circuit comprising at least one dummy touch receiving terminal from the at least one dummy touch terminal that is connected to a second dummy touch line from the dummy touch line that overlaps with the plurality of touch receiving lines.

In one embodiment, the plurality of touch electrodes comprises: a plurality of touch receiving electrodes extending in a first direction, the plurality of touch receiving electrodes having a bar shape; and a plurality of touch transmitting electrodes extending in a second direction that intersects the first direction, wherein each of the plurality of touch transmitting electrodes is connected to at least one adjacent touch transmitting electrode from the plurality of touch transmitting electrodes through at least one bridge pattern.

In one embodiment, the plurality of touch lines and the dummy touch line are disposed in different layers.

In one embodiment, the display panel comprises: a first touch insulating layer on which the plurality of touch lines are disposed; and a second touch insulating layer on the first touch insulating layer, the second touch insulating layer covering the plurality of touch lines, wherein the dummy touch line is on the second touch insulating layer such that the dummy touch line at least partially overlaps with one or more of the plurality of touch lines.

In one embodiment, a touch display device comprises: a substrate; a plurality of insulating layers on the substrate; a light emitting element layer on the plurality of insulating layers, the light emitting element layer emitting light; a first touch insulating layer on the light emitting element layer; a plurality of touch lines on the first touch insulating layer; a second touch insulating layer on the first touch insulating layer, the second touch insulating layer covering the plurality of touch lines, and a dummy touch line at least partially overlapping with at least one of the plurality of touch lines, the dummy touch line connected to at least one dummy touch terminal in a touch driving circuit.

A touch display device comprising: a display panel comprising a plurality of subpixels that display an image, a plurality of touch electrodes that perform touch sensing, a plurality of touch lines that are connected to the plurality of touch electrodes and extend in a first direction, and a dummy touch line; and a touch driving circuit electrically connected to the plurality of touch electrodes through the plurality of touch lines, the touch driving circuit including at least one dummy touch terminal connected to the dummy touch line, wherein the dummy touch line includes a first portion and a second portion that extend in the first direction and a third portion that is connected to a first end of the first portion and a first end of the second portion, wherein the third portion of the dummy touch line extends in a second direction that intersects the first direction such that the third portion overlaps at least one of the plurality of touch lines.

In one embodiment, the touch driving circuit includes a first dummy touch terminal and a second dummy touch terminal, and a second end of the first portion of the dummy touch line is connected to the first dummy touch terminal and a second end of the second portion of the dummy touch line is connected to the second dummy touch terminal.

In one embodiment, the dummy touch line is connected to a touch line from the plurality of touch lines and the touch line includes a cut that is located between where the dummy touch line is connected to the touch line and an end of the touch line that is connected to the touch driving circuit.

In one embodiment, the touch driving circuit is configured to apply a touch driving signal to the dummy touch line through the at least one dummy touch terminal at a time corresponding to when the touch driving signal is supposed to be supplied to the touch line.

In one embodiment, the display panel comprises: a first touch insulating layer on which the plurality of touch lines are disposed; and a second touch insulating layer on the first touch insulating layer, the second touch insulating layer covering the plurality of touch lines, wherein the dummy touch line is on the second touch insulating layer such that the dummy touch line at least partially overlaps with the at least one of the plurality of touch lines.

In one embodiment, the third portion of the dummy touch line overlaps the plurality of touch lines.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the principles described herein may be applied to other embodiments and applications without departing from the scope of the present disclosure. The above description and the accompanying drawings provide an example of the technical idea of the present disclosure for illustrative purposes only. That is, the disclosed embodiments are intended to illustrate the scope of the technical idea of the present disclosure.

What is claimed is:

1. A touch display device comprising:
a display panel comprising a plurality of subpixels that display an image, a plurality of touch electrodes that perform touch sensing, a plurality of touch lines that are connected to the plurality of touch electrodes, and a dummy touch line; and
a touch driving circuit electrically connected to the plurality of touch electrodes through the plurality of touch lines, the touch driving circuit including at least one dummy touch terminal connected to the dummy touch line,
wherein the dummy touch line overlaps the plurality of touch lines.

2. The touch display device of claim 1, wherein the plurality of touch lines extend in a first direction and the dummy touch line has a loop shape, the loop shape including a portion that extends in a second direction that intersects the first direction such that the portion of the loop shape overlaps the plurality of touch lines.

3. The touch display device of claim 1, wherein both ends of the dummy touch line are connected to a same dummy touch terminal from the at least one dummy touch terminal.

4. The touch display device of claim 1, wherein a first end of the dummy touch line is connected to a first dummy touch terminal from the at least one dummy touch terminal and a second end of the dummy touch line is connected to a second dummy touch terminal from the at least one dummy touch terminal.

5. The touch display device of claim 4, wherein the touch driving circuit comprises a plurality of touch driving terminals connected to the plurality of touch lines, and
wherein the first dummy touch terminal is disposed on a first side of the plurality of touch driving terminals and the second dummy touch terminal is disposed on a second side of the plurality of touch driving terminals that is opposite the first side.

6. The touch display device of claim 1, wherein the dummy touch line is electrically connected to one touch line among the plurality of touch lines at an area overlapping with the plurality of touch lines.

7. The touch display device of claim 6, wherein the one touch line includes a cut at a location that is disposed between a location where the one touch line is connected to the dummy touch line and a location where the one touch line is connected to one touch driving terminal in the touch driving circuit.

8. The touch display device of claim 6, wherein the touch driving circuit is configured to apply a touch driving signal to the dummy touch line through the at least one dummy touch terminal at a time corresponding to when the touch driving signal is supposed to be supplied to the one touch line.

9. The touch display device of claim 6, wherein the dummy touch line is electrically connected to another touch line among the plurality of touch lines in the area overlapping with the plurality of touch lines.

10. The touch display device of claim 9, wherein the dummy touch line is cut at a location of the dummy touch line, between the location where the dummy touch line is connected to the one touch line and a location where the dummy touch line is connected to the other touch line.

11. The touch display device of claim 10, wherein the other touch line is cut at a location that is disposed between the location where the dummy touch line is connected to the other touch line and a location where the other touch line is electrically connected to another touch driving terminal in the touch driving circuit.

12. The touch display device of claim 9, wherein the touch driving circuit is configured to apply a touch driving signal to the dummy touch line through the at least one dummy touch terminal at a time corresponding to when the touch driving signal is supposed to be supplied to the other touch line.

13. The touch display device of claim 1, wherein the touch driving circuit comprises:
a touch transmitting circuit connected to a plurality of touch transmitting lines among the plurality of touch lines, the touch transmitting circuit comprising at least one dummy touch transmitting terminal from the at least one dummy touch terminal that is connected to a first dummy touch line from the dummy touch line that overlaps the plurality of touch transmitting lines; and
a touch receiving circuit connected to a plurality of touch receiving lines among the plurality of touch lines, the touch receiving circuit comprising at least one dummy touch receiving terminal from the at least one dummy touch terminal that is connected to a second dummy touch line from the dummy touch line that overlaps with the plurality of touch receiving lines.

14. The touch display device of claim 1, wherein the plurality of touch electrodes comprises:
a plurality of touch receiving electrodes extending in a first direction, the plurality of touch receiving electrodes having a bar shape; and
a plurality of touch transmitting electrodes extending in a second direction that intersects the first direction,
wherein each of the plurality of touch transmitting electrodes is connected to at least one adjacent touch transmitting electrode from the plurality of touch transmitting electrodes through at least one bridge pattern.

15. The touch display device of claim 1, wherein the plurality of touch lines and the dummy touch line are disposed in different layers.

16. The touch display device of claim 15, wherein the display panel comprises:
a first touch insulating layer on which the plurality of touch lines are disposed; and
a second touch insulating layer on the first touch insulating layer, the second touch insulating layer covering the plurality of touch lines,
wherein the dummy touch line is on the second touch insulating layer such that the dummy touch line at least partially overlaps with one or more of the plurality of touch lines.

17. A touch display device comprising:
a substrate;
a plurality of insulating layers on the substrate;
a light emitting element layer on the plurality of insulating layers, the light emitting element layer emitting light;
a first touch insulating layer on the light emitting element layer;
a plurality of touch lines on the first touch insulating layer;
a second touch insulating layer on the first touch insulating layer, the second touch insulating layer covering the plurality of touch lines, and
a dummy touch line at least partially overlapping with at least one of the plurality of touch lines, the dummy touch line connected to at least one dummy touch terminal in a touch driving circuit.

18. A touch display device comprising:
a display panel comprising a plurality of subpixels that display an image, a plurality of touch electrodes that perform touch sensing, a plurality of touch lines that are connected to the plurality of touch electrodes and extend in a first direction, and a dummy touch line; and
a touch driving circuit electrically connected to the plurality of touch electrodes through the plurality of touch lines, the touch driving circuit including at least one dummy touch terminal connected to the dummy touch line,
wherein the dummy touch line includes a first portion and a second portion that extend in the first direction and a third portion that is connected to a first end of the first portion and a first end of the second portion,
wherein the third portion of the dummy touch line extends in a second direction that intersects the first direction such that the third portion overlaps at least one of the plurality of touch lines.

19. The touch display device of claim 18, wherein the touch driving circuit includes a first dummy touch terminal and a second dummy touch terminal, and a second end of the first portion of the dummy touch line is connected to the first dummy touch terminal and a second end of the second portion of the dummy touch line is connected to the second dummy touch terminal.

20. The touch display device of claim 18, wherein the dummy touch line is connected to a touch line from the plurality of touch lines and the touch line includes a cut that is located between where the dummy touch line is connected to the touch line and an end of the touch line that is connected to the touch driving circuit.
